(19) United States
(12) Patent Application Publication
(10) Pub. No.: US 2014/0246230 A1
(43) Pub. Date: Sep. 4, 2014

(54) WIRE HARNESS AND METHOD OF MANUFACTURING SAME

(71) Applicant: Yuten Takahashi, Mie (JP)

(72) Inventor: Yuten Takahashi, Mie (JP)

(73) Assignee: SUMITOMO WIRING SYSTEMS, LTD., Mie (JP)

(21) Appl. No.: 14/237,198

(22) PCT Filed: Jun. 7, 2012
(86) PCT No.: PCT/JP2012/064633

§ 371 Date: Feb. 5, 2014

(30) Foreign Application Priority Data
Sep. 16, 2011 (JP) 2011-203008

(51) Int. Cl. H01B 13/012; H01B 7/00

(52) U.S. Cl. CPC H01B 13/01263; H01B 7/0045
USPC 174/72 A; 156/51

(57) ABSTRACT

An object is to readily fixate a wire to a nonwoven member at low cost and to reduce waste when the nonwoven member is wound around the wire. A wire harness includes a wire bundle and a nonwoven fabric extending in a longitudinal direction of the wire bundle and being wound and wrapped around the wire bundle. In the wire harness, the nonwoven fabric is fixated to the wire bundle by welding at least one of a start-edge portion and an end-edge portion in a winding direction of the nonwoven fabric.

### TECHNICAL FIELD

The present invention relates to a technology to fixate a nonwoven member to an electric wire in production of a wire harness.

### BACKGROUND ART

A technology is conventionally known in which a flat circuit body (electric wire) is placed between two covering bodies composed of a thermoplastic material and the two covering bodies are heated and compressed to form a protector (Patent Literature 1, for example).

### CITATION LIST

### Patent Literature

Patent Literature 1: Japanese Patent Laid-Open Publication No. 2003-197038

### SUMMARY OF INVENTION

### Technical Problem

A nonwoven member or the like is employed as a thermoplastic material to be wound around a wire to form a protector. To prevent the nonwoven member from shifting sideways relative to the wire when or after being wound around the wire, a double-sided tape could be attached in advance in a start-edge portion and an end-edge portion in a winding direction of the nonwoven member. The wire is placed on the double-sided tape attached to the start-edge portion in the winding direction of the nonwoven member such that the wire is fixated to the start-edge portion of the nonwoven member by the double-sided tape. Then, the wire is rolled toward the end-edge portion in the winding direction of the nonwoven member to wind the nonwoven member around the wire. The end-edge portion of the nonwoven member is fixated by the double-sided tape attached thereto to an outer peripheral portion of the nonwoven member wound around the wire. Thereafter, the nonwoven member is heated and compressed.

However, using the double-sided tape every time winding the nonwoven member around the wire incurs material cost of the double-sided tape and control man hours associated with inventory control of the double-sided tape, thus increasing production cost of a wire harness. In addition, to prevent the double-sided tape from protruding from a protection portion after heating and compression, the double-sided tape needs to be attached to the end-edge portion in the winding direction of the nonwoven member in a position only 2 to 3 mm from the end edge. It is difficult to attach the double-sided tape to such a precise position. Furthermore, a backing sheet needs to be peeled off before attaching the double-sided tape, thus increasing the amount of waste.

In view of the above, the present invention is intended to readily fixate a wire to a nonwoven member at low cost and to reduce waste when the nonwoven member is wound around the wire.

### Solution to Problem

To address the circumstances above, a first aspect provides a wire harness including a wire and a nonwoven member extending in a longitudinal direction of the wire and being wound and wrapped around the wire. The nonwoven member is fixated to the wire by welding at least one of a start-edge portion and an end-edge portion in a winding direction of the nonwoven member.

A second aspect provides the wire harness according to the first aspect, in which the nonwoven member is fixated to the wire by separately welding the start-edge portion and the end-edge portion in the winding direction of the nonwoven member.

A third aspect provides the wire harness according to the first or second aspect, in which a protection portion is formed by hot-pressing the nonwoven member in a state of covering the wire.

A fourth aspect provides the wire harness according to one of the first to third aspects, in which a plurality of wires are provided and the start-edge portion in the winding direction of the nonwoven member is inserted between at least one wire of the plurality of wires and a wire adjacent to the one wire.

A fifth aspect provides a method of producing a wire harness including a wire and a nonwoven member wound around the wire. The method includes a process (a) of welding at least one of a start-edge portion and an end-edge portion in a winding direction of the nonwoven member to fixate the nonwoven member to the wire and of winding the nonwoven member around the wire.

A sixth aspect provides the method of producing the wire harness according to the fifth aspect, in which, in the process (a), the nonwoven member is fixated to the wire by separately welding the start-edge portion and the end-edge portion in the winding direction of the nonwoven member.

A seventh aspect provides the method of producing the wire harness according to the fifth or sixth aspect, further including a process (b) of hot-pressing the nonwoven member in a state of covering the wire to form a protection portion.

An eighth aspect provides the method of producing the wire harness according to one of fifth to seventh aspects, in which a plurality of wires are provided and, in the process (a), before the nonwoven member is wound around the plurality of wires, the start-edge portion in the winding direction of the nonwoven member is inserted between at least one wire of the plurality of wires and a wire adjacent to the one wire.

### ADVANTAGEOUS EFFECTS OF INVENTION

According to the first aspect, the nonwoven member can be fixated to the wire without using a double-sided tape. This eliminates material cost of a double-sided tape and control man hours associated therewith, thus reducing production cost of the wire harness. Furthermore, welding facilitates fixation and reduces waste.

According to the second aspect, the nonwoven member can be prevented from shifting sideways relative to the wire. Thus, the nonwoven member can be readily wound around the wire and the quality of the wire harness is improved.

According to the third aspect, the protection portion can regulate a path.

According to the fourth aspect, the nonwoven member can be further prevented from shifting sideways relative to the wire at the start of winding the nonwoven member. Thus, the nonwoven member can be further readily wound around the wire.

According to the fifth aspect, the nonwoven member can be fixated to the wire without using a double-sided tape. This eliminates material cost of a double-sided tape and control man hours associated therewith, thus reducing production cost of the wire harness. Furthermore, welding facilitates fixation and reduces waste.

According to the sixth aspect, the nonwoven member can be prevented from shifting sideways relative to the wire. Thus, the quality of the wire harness can be improved and the nonwoven member can be readily wound around the wire.

According to the seventh aspect, the protection portion can regulate a path.

According to the eighth aspect, the nonwoven member can be further prevented from shifting sideways relative to the wire at the start of winding the nonwoven member. Thus, the nonwoven member can be further readily wound around the wire.

### BRIEF DESCRIPTION OF DRAWINGS

FIG. 1 A schematic perspective view of a wire harness according to a first embodiment.

FIG. 2 A side view of the wire harness according to the first embodiment.

FIG. 3 A plan view illustrating a state where a gap is defined between a wire bundle and a single wire according to the first embodiment.

FIG. 4 A plan view illustrating a state where a nonwoven member is passed through between the wire bundle and the single wire according to the first embodiment.

FIG. 5 A plan view illustrating a state where a start-edge portion in a winding direction of the nonwoven member is welded.

FIG. 6 A plan view illustrating a state where an end-edge portion in the winding direction of the nonwoven member is welded.

FIG. 7 A schematic perspective view of a wire harness according to a second embodiment.

FIG. 8 A side view of the wire harness according to the second embodiment.

FIG. 9 A schematic perspective view of an exemplary hot-pressing mold for producing the wire harness according to the second embodiment.

FIG. 10 A view illustrating a process of producing the wire harness using the hot-pressing mold according to the second embodiment.

FIG. 11 A view illustrating a process of producing the wire harness using the hot-pressing mold according to the second embodiment.

### DESCRIPTION OF EMBODIMENTS

### First Embodiment

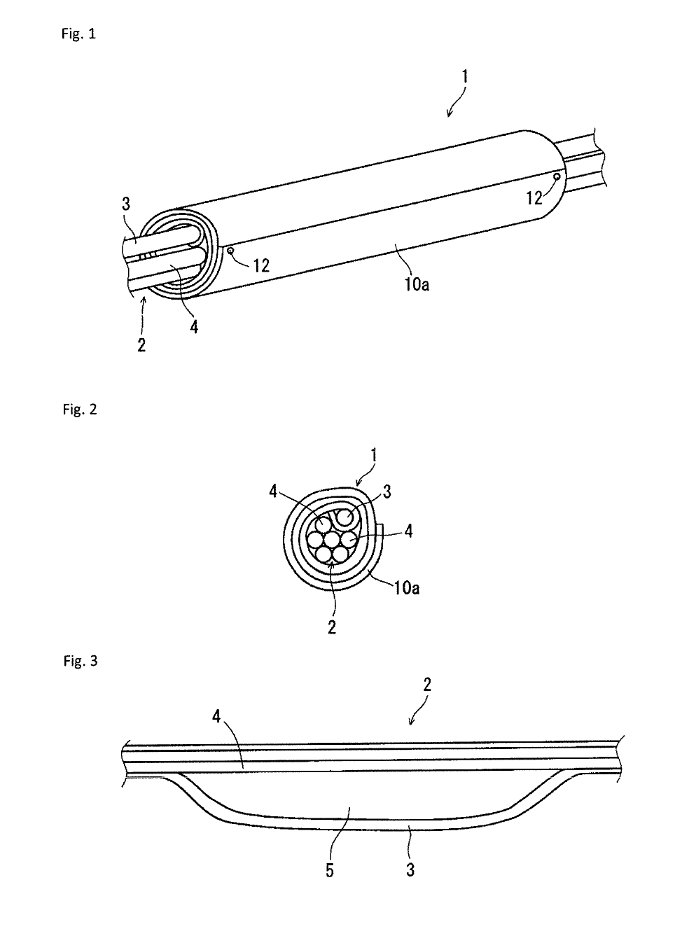

A wire harness 1 according to a first embodiment is described below. FIG. 1 is a schematic perspective view of the wire harness 1; FIG. 2 is a side view of the wire harness 1.

The wire harness 1 has a wire bundle 2 bundling a plurality of wires 3 and 4 (five wires in the present embodiment) and a nonwoven fabric 10a (nonwoven member) extending in a longitudinal direction of the wire bundle 2 and being wound and wrapped around a portion of the wire bundle 2. The wire bundle 2 is assumed to be included in the wire harness 1 that makes electrical connections among electric devices in a vehicle or the like. Of course, the wire wrapped around by the nonwoven fabric 10a may be a wire bundle or a single wire. Furthermore, the nonwoven fabric 10a may wrap around the entire longitudinal direction of the wire bundle 2.

A start-edge portion in a winding direction of the nonwoven fabric 10a is inserted between one wire 3 of the wire bundle 2 and two wires 4 adjacent thereto, and then are folded toward an end-edge portion in the winding direction of the nonwoven fabric 10a. The start-edge portion in the winding direction of the nonwoven fabric 10a and a portion overlapping therewith are welded in a plurality of (two, for example) welding portions 11 (refer to FIG. 5) for fixation. A circular recess in a plan view is provided in each of the welding portions 11. The end-edge portion in the winding direction of the nonwoven fabric 10a overlaps an outer peripheral portion of the nonwoven fabric 10a wound around the wire bundle 2. The end-edge portion of the nonwoven fabric 10a and a portion overlapping therewith are welded in a plurality of (two, for example) welding portions 12 for fixation. A circular recess in a plan view is provided in each of the welding portions 12. Examples of the welding may include ultrasonic welding with an ultrasonic stapler or heat welding with a small iron. In the present embodiment, ultrasonic welding with an ultrasonic stapler is employed, where one portion is welded in approximately 0.8 second and a recess having a depth of approximately 2 mm is formed in each of the welding portions 11 and 12.

Of course, either of the start-edge portion or the end-edge portion in the winding direction of the nonwoven fabric 10a may be fixated by welding while the remaining portion may be left alone. The start-edge portion and the end-edge portion in the winding direction of the nonwoven fabric 10a could also be fixated using a metal stapler. In the present embodiment, however, welding is employed for fixation, which reduces material cost compared to a case of using a metal stapler and leaves no metal staple in the nonwoven fabric 10a.

For the nonwoven fabric, a member having a thermoplastic resin fiber that allows ultrasonic welding can be used. An ultrasonic stapler welds the nonwoven fabric by pressuring and applying ultrasonic vibration to the welding portion thereof.

According to the wire harness 1 configured as above, the nonwoven fabric 10a can be fixated to the wire bundle 2 without using a double-sided tape. This eliminates material cost of a double-sided tape and control man hours associated therewith, thus reducing production cost of the wire harness 1. In addition, fixating the nonwoven fabric 10a to the wire bundle 2 by welding eliminates the necessity of attaching the double-sided tape to a precise position in the end-edge portion in the winding direction of the nonwoven fabric 10a, thus facilitating fixation. Furthermore, using no double-sided tape reduces waste.

The start-edge portion and the end-edge portion in the winding direction of the nonwoven fabric 10a are separately welded to fixate the nonwoven fabric 10a to the wire bundle 2. This prevents the nonwoven fabric 10a from shifting sideways relative to the wire bundle 2. Thus, the nonwoven fabric 10a can readily be wound around the wire and the quality of the wire harness 1 is improved.

The start-edge portion in the winding direction of the nonwoven fabric 10a is inserted between the one wire 3 of the wire bundle 2 and the two wires 4 adjacent thereto. This further prevents the nonwoven fabric 10a from shifting sideways relative to the wire bundle 2 at the start of winding the nonwoven fabric 10a and further facilitates winding of the nonwoven fabric 10a around the wire bundle 2. In particular, when the nonwoven fabric 10a is wound around the wire bundle 2, the wire bundle 2 does not need to be rolled in the winding direction of the nonwoven fabric 10a. Thus, the nonwoven fabric 10a can be wound around the wire bundle 2 even when placed perpendicularly.

<Production Method>

A method of producing the wire harness 1 according to an embodiment is described.

The wire harness 1 can be produced in a method of production including a process (a), in which, before the nonwoven fabric 10a is wound around the wire bundle 2, the start-edge portion in the winding direction of the nonwoven fabric 10a is inserted between the one wire 3 of the wire bundle 2 and the two wires 4 adjacent thereto; the start-edge portion and the end-edge portion in the winding direction of the nonwoven fabric 10a are separately welded to fixate the nonwoven fabric 10a to the wire bundle 2; and thus the nonwoven fabric 10a is wound around the wire bundle 2.

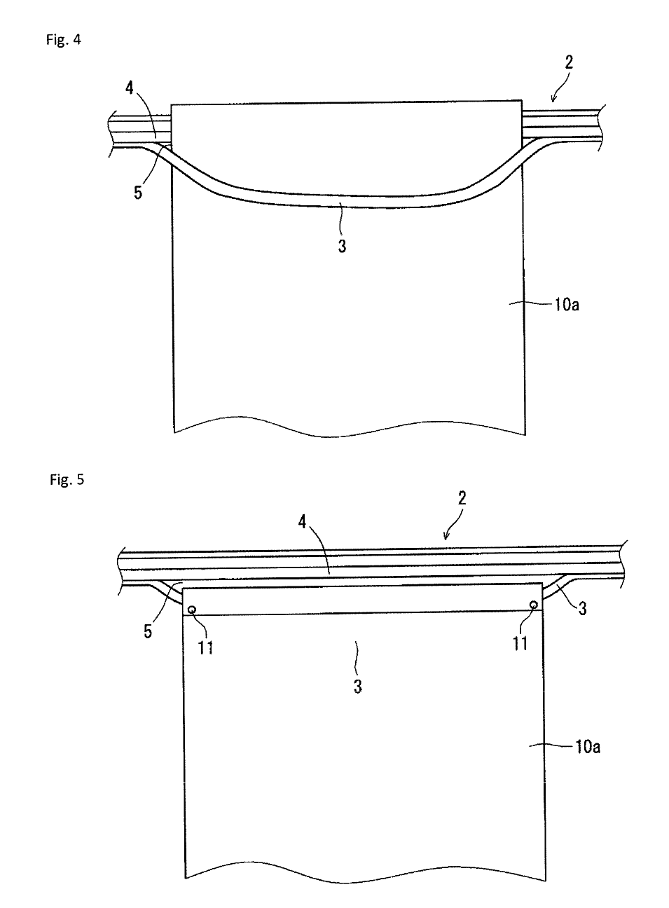

The method of producing the wire harness 1 is described. The wire bundle 2 is wired along a predetermined wiring line. With reference to FIG. 3, a gap 5 is defined between the wire bundle 2 and the wire 3 with a predetermined distance from the wire bundle 2 in a portion excluding two end portions in the longitudinal direction of the one wire 3. With reference to FIG. 4, the start-edge portion (for example, 10 mm from the start-edge) in the winding direction of the nonwoven fabric 10a is inserted through the gap 5 between the wire bundle 2 and the wire 3. With reference to FIG. 5, in a state where the start-edge portion in the winding direction of the nonwoven fabric 10a is folded toward the end-edge portion to cover a portion of the one wire 3, the start-edge portion in the winding direction of the nonwoven fabric 10a and a portion overlapping therewith are welded in the welding portions 11 to fixate the start-edge portion in the winding direction of the nonwoven fabric 10a to the wire 3.

Of course, the start-edge portion in the winding direction of the nonwoven fabric 10a and the portion overlapping therewith may be welded in a state where the start-edge portion in the winding direction of the nonwoven fabric 10a is inserted through a gap between the wire bundle 2 and two or more wires and is folded toward the end-edge portion to cover a portion of the two or more wires. Alternatively, the nonwoven fabric 10a may be wrapped around the wire bundle 2 one time, and then the start-edge portion in the winding direction of the nonwoven fabric 10a and the portion overlapping therewith may be welded. In a case where a wire harness has one wire and the nonwoven fabric 10a, the start-edge portion in the winding direction of the nonwoven fabric 10a and the portion overlapping therewith may be welded in a state where the start-edge portion in the winding direction of the nonwoven fabric 10a is folded toward the end-edge portion to cover a portion of the wire.

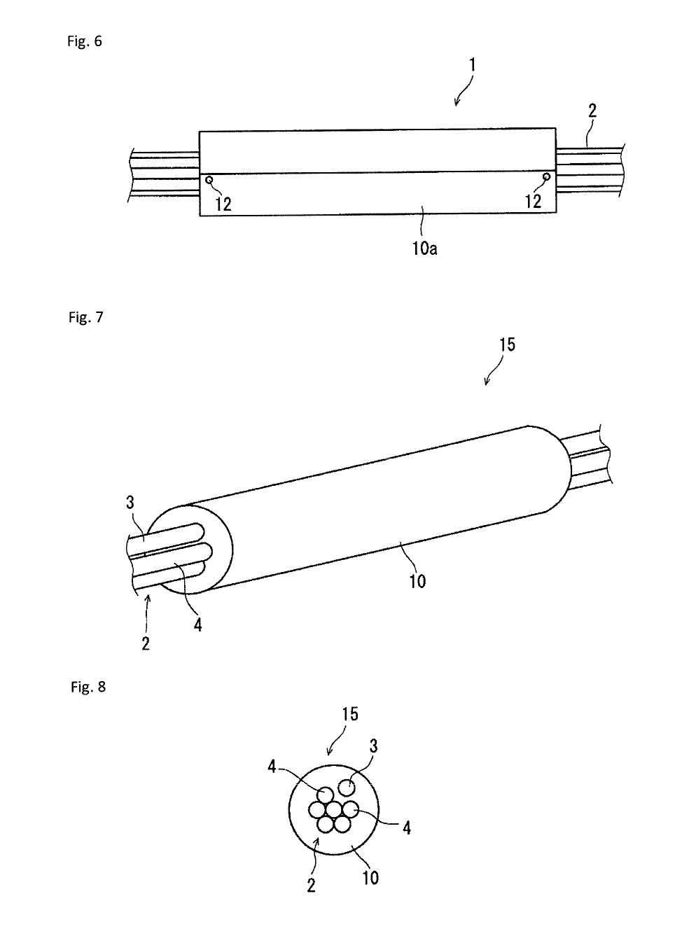

Then, the nonwoven fabric 10a is wound around the wire bundle 2. With reference to FIG. 6, in a state where the end-edge portion in the winding direction of the nonwoven fabric 10a overlaps an outer peripheral surface of the nonwoven fabric 10a, the end-edge portion of the nonwoven fabric 10a and a portion overlapping therewith are welded in the welding portions 12 to fixate the end-edge portion in the winding direction of the nonwoven fabric 10a to the nonwoven fabric 10a wound around the wire bundle 2. Thus, the wire harness 1 is produced.

### Second Embodiment

<Configuration of Wire Harness>

A wire harness 15 according to a second embodiment is described below. FIG. 7 is a schematic perspective view of the wire harness 15; FIG. 8 is a side view of the wire harness 15. In the description of the second embodiment, components similar to those described in the first embodiment are denoted by the same reference numerals and descriptions thereof are omitted.

The wire harness 15 has the wire bundle 2 and a protection portion 10 protecting a portion of the wire bundle 2. The protection portion 10 has a circular shape in cross section substantially orthogonal to an extending direction of the wire bundle 2. The protection portion 10 is formed by inserting the start-edge portion in the winding direction of the nonwoven fabric 10a between the one wire 3 of the wire bundle 2 and the two wires 4 adjacent thereto, and by hot-pressing the nonwoven fabric 10a in a state of covering a portion of the wire bundle 2. Thus, the protection portion 10 is provided between the one wire 3 and the two wires 4, and the wire 3 and the wires 4 are slightly distanced apart. Of course, the start-edge portion in the winding direction of the nonwoven fabric 10a may be inserted between two or more wires and a wire adjacent thereto. Furthermore, the protection portion 10 may protect the wire bundle 2 in the entire longitudinal direction.

The cross-sectional shape of the protection portion 10 is not limited to a circular shape, and may be a rectangular shape or another polygonal shape (triangular, hexagonal, or the like). Furthermore, the cross-sectional shape may differ along the extending direction of the wire bundle 2.

A nonwoven fabric that can be hardened in a heating process can be used for the nonwoven member. Such a nonwoven fabric includes interwoven elementary fiber and adhesive resin (also referred to as binder). The adhesive resin has a lower melting point (for example, 110° C. to 115° C.) than that of the elementary fiber. The nonwoven fabric is heated at a processing temperature lower than the melting point of the elementary fiber and higher than the melting point of the adhesive resin, and then the adhesive resin melts and seeps in between the elementary fibers. Thereafter, the temperature of the nonwoven fabric lowers below the melting point of the adhesive resin, and then the adhesive resin is solidified in a state where the elementary fibers are bound together. Thus, the nonwoven fabric becomes harder than in a pre-heating state and is maintained in a shape formed at the time of heating.

The adhesive resin may be granular or fibrous. A binder fiber may be provided by forming an adhesive resin layer around an outer periphery of a core fiber and be interwoven with the elementary fiber. The core fiber in this case can be the same material as the elementary fiber.

Any fiber capable of maintaining a fibrous state at the melting point of the adhesive resin can be used as the elementary fiber. Other than a resin fiber, various kinds of fibers can be used. Furthermore, a thermoplastic resin fiber, which has a melting point lower than the elementary fiber, can be used as the adhesive resin. An exemplary combination of the elementary fiber and the adhesive resin may include a resin fiber composed of PET (polyethylene terephthalate) as the elementary fiber and a copolymer resin composed of PET and PEI (polyethylene isophthalate) as the adhesive resin. In this case, the melting point of the elementary fiber is approximately 250° C., while the melting point of the adhesive resin is 110° C. to 150° C. Thus, when the nonwoven fabric is heated at a temperature of 110° C. to 250° C., the adhesive resin melts and seeps in between the elementary fibers, which do not melt and hold a fibrous shape. When the temperature of the nonwoven fabric then lowers below the melting point of the adhesive resin, the adhesive resin is solidified in a state where the elementary fibers are bound together, and the nonwoven fabric is hardened and maintained in a shape formed at the time of heating. When the melted adhesive resin seeps into a contact portion between the nonwoven fabrics, the adhesive resin binds the nonwoven fabrics together.

Hot-pressing is a process in which a nonwoven fabric to be processed is inserted between molds and is molded by pressuring the molds in a heated state. A specific example of hot-pressing suitable for forming the protection portion 10 will be described later.

According to the wire harness 15 configured as above, the hot-pressed protection portion 10 can regulate a path.

<Production Method>

A method of producing the wire harness 15 according to an embodiment is described.

The wire harness 15 can be produced in a method of production including the process (a) of the first embodiment and a process (b), in which the nonwoven fabric 10a is hot-pressed in a state of covering the wire bundle 2 to form the protection portion 10.

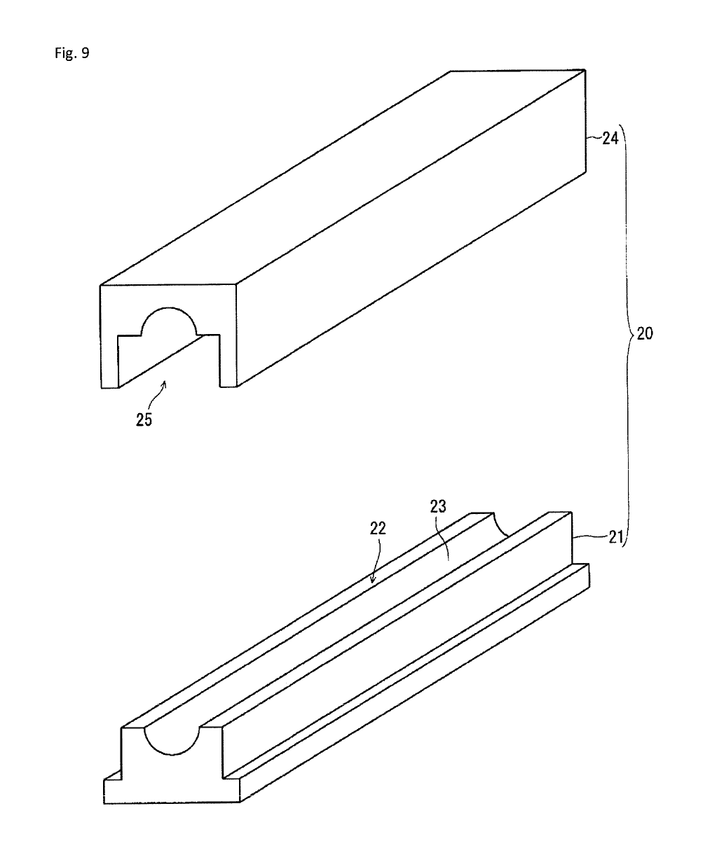

FIG. 9 is a schematic perspective view of an exemplary hot-pressing mold 20 for producing the protection portion 10. A shape of the hot-pressing mold 20 is determined according to a shape of the protection portion 10 to be produced. FIG. 9 illustrates the hot-pressing mold 20 used to produce the protection portion 10 having a shape illustrated in FIGS. 7 and 8.

The hot-pressing mold 20 has a lower mold 21 and an upper mold 24. The lower mold 21, which is an elongated member formed of metal or the like having excellent thermal conductivity, has a lower mold surface 22 on one main surface (upper surface) thereof. The lower mold surface 22 has a groove 23 having substantially a circular shape in cross section open upward and to two sides. A length in an extending direction of the groove 23 is substantially the same as a length of a protected portion of the wire bundle 2 (portion of the wire bundle 2 to be covered by the protection member 10).

The upper mold 24, which is an elongated member formed of metal or the like having excellent thermal conductivity, has an upper mold surface 25 on one main surface (lower surface) thereof. The upper mold surface 25 has the same shape as the lower mold surface 22. Placing the upper mold surface 25 opposite and proximate to the lower mold surface 22 defines the protection portion 10 between the upper mold surface 25 and the lower mold surface 22.

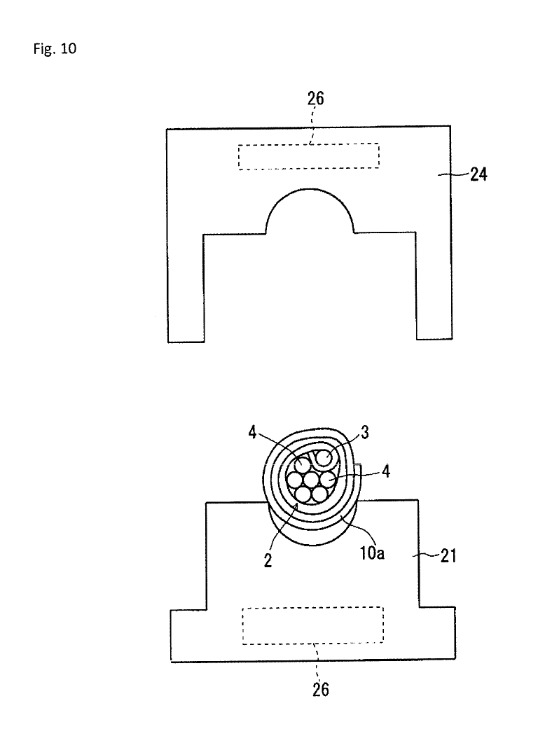

A heater 26 (refer to FIG. 10) serving as a heating device is provided to the lower mold 21 and the upper mold 24. The heater 26 heats the lower mold surface 22 and the upper mold surface 25 at a temperature lower than the melting point of the elementary fiber and higher than the melting point of the adhesive resin. The heater 26 may be, for example, embedded in the lower mold 21 and the upper mold 24. Alternatively, the heater 26 may be attached to outer surfaces of the lower mold 21 and the upper mold 24 in a heat-transferable manner.

A method of producing the wire harness 15 using the hot-pressing mold 20 is described. Similar to the first embodiment, the wire bundle 2 is wired along a predetermined wiring line; the start-edge portion in the winding direction of the nonwoven fabric 10a is inserted between the one wire 3 and the two wires 4 adjacent thereto; and the start-edge portion the winding direction of the nonwoven fabric 10a is welded. Then, the nonwoven fabric 10a is wound around the wire bundle 2, and the end-edge portion in the winding direction of the nonwoven fabric 10a is welded to fixate the nonwoven fabric 10a to the wire bundle 2.

With reference to FIG. 10, the wire bundle 2 and the nonwoven fabric 10a are placed on the lower mold surface 22 of the lower mold 21. Specifically, a portion of the wire bundle 2 wrapped around by the nonwoven fabric 10a is placed in the groove 23 of the lower mold surface 22 in the extending direction.

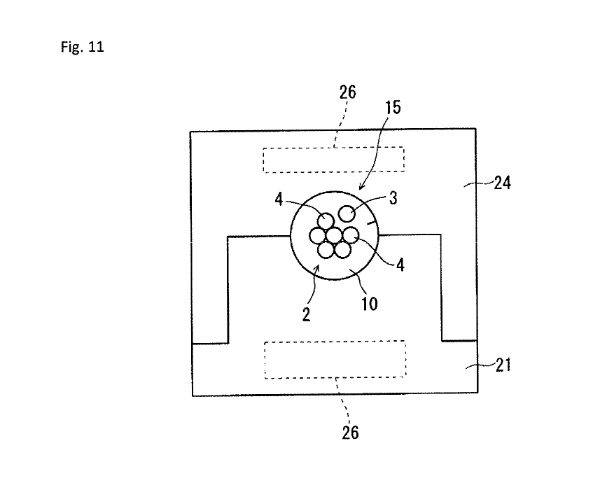

Then, with reference to FIG. 11, in a state where the lower mold 21 and the upper mold 24 heated by the heater 26, the lower mold 21 and the upper mold 24 are brought proximate to each other and a portion therebetween is pressured. The nonwoven fabric 10a is then compressed in a state of covering the wire bundle 2. Thereby, the protection member 10 having a circular shape in cross section is produced. The recesses formed in the welding portions 11 and 12 disappear when being hot-pressed together with surrounding areas. Thereafter, the lower mold 21 and the upper mold 24 are moved apart, and the wire harness 15 is removed from therebetween. Cooling after hot-pressing may be performed in a state where the wire harness 15 is present between the lower mold 21 and the upper mold 24, or after being removed from therebetween. Furthermore, a mold having a bent groove may be used to allow the protection portion 10 to bend during hot-pressing to fit a path of the wire harness 15.

The detailed description above of the present invention is presented merely as an example in all aspects and should not limit the present invention. Innumerable modifications not presented are construed to be assumed without deviating from the scope of the present invention.

1. A wire harness comprising:
a wire; and
a nonwoven member extending in a longitudinal direction of the wire and being wound and wrapped around the wire, wherein
the nonwoven member is fixated to the wire by welding at least one of a start-edge portion and an end-edge portion in a winding direction of the nonwoven member.

2. The wire harness according to claim 1, wherein the nonwoven member is fixated to the wire by separately welding the start-edge portion and the end-edge portion in the winding direction of the nonwoven member.

3. The wire harness according to claim 1, wherein a protection portion is formed by hot-pressing the nonwoven member covering the wire.

4. The wire harness according to claim 1, wherein a plurality of wires are provided and the start-edge portion in the winding direction of the nonwoven member is inserted between at least one wire of the plurality of wires and a wire adjacent to the one wire.

5. A method of producing a wire harness comprising a wire and a nonwoven member wound around the wire, the method comprising:
welding at least one of a start-edge portion and an end-edge portion in a winding direction of the nonwoven member to fixate the nonwoven member to the wire; and
winding the nonwoven member around the wire.

6. The method of producing the wire harness according to claim 5, wherein the nonwoven member is fixated to the wire by separately welding the start-edge portion and the end-edge portion in the winding direction of the nonwoven member.

7. The method of producing the wire harness according to claim 5, further comprising:
hot-pressing the nonwoven member covering the wire to form a protection portion.

8. The method of producing the wire harness according to claim 5, wherein
a plurality of wires are provided, and
before the nonwoven member is wound around the plurality of wires, the start-edge portion in the winding direction of the nonwoven member is inserted between at least one wire of the plurality of wires and a wire adjacent to the one wire.
